(19) United States
(12) Patent Application Publication
(10) Pub. No.: US 2026/0217454 A1
(43) Pub. Date: Jul. 30, 2026

(54) SYSTEMS AND METHODS FOR ENABLING MOBILE ROBOT PASSAGE THROUGH A DOOR-CONTROLLED DOORWAY OF A STORAGE STRUCTURE

(71) Applicant: Symbotic LLC, Wilmington, MA (US)

(72) Inventors: Viengamphay Pi Amkhamavong, Sterling, MA (US); Mark B. Wyer, Nashua, NH (US)

(21) Appl. No.: 19/041,704

(22) Filed: Jan. 30, 2025

(51) Int. Cl. E05F 15/73; B65G 1/04; F25D 23/02

(52) U.S. Cl. CPC B65G 1/04; F25D 23/02

(57) ABSTRACT

Systems and methods for enabling mobile robots to travel through a doorway between two separate sections of a storage structure include a door configured to move between a closed position, where the door obstructs the doorway, and an open position, where the door does not obstruct the doorway. Rails move between a first position, where the rails obstruct the doorway, and a second position, where the rails do not obstruct the doorway. A frame including pivots is coupled to the rails. When the door is in the open position, the rails are in the second position, and a mobile robot is permitted to travel, on the rails and through the doorway, between two separate sections of the storage structure. When the door is in the closed position, the rails are in the first position, and the mobile robot is not permitted to travel, on the rails and through the doorway.

### TECHNICAL FIELD

This disclosure relates generally to temperature-controlled product storage systems, more particularly, to multi-section product storage structures where mobile robots retrieve and move between different sections.

### BACKGROUND

In automated storage and retrieval systems, particularly those used in environments with temperature-sensitive sections such as chilled and frozen storage, there is a need for efficient, reliable systems to manage the movement of mobile robots between these sections. A challenge arises when a doorway separates the sections, as the door must be able to block or unblock the pathway, while still allowing for seamless robot movement. In many cases, the rails that guide the mobile robots must be moved to clear the doorway when the door opens, yet be secured when the door is closed. Existing solutions often fail to provide a simple, reliable method of coordinating the movement of the rails with the door, or securing the rails in the open position without complex or prone-to-failure mechanisms. Additionally, detecting the position of the rails to ensure they remain properly aligned is often not addressed. Thus, there is a need for a system that can efficiently coordinate the movement of rails with a door, securely hold the rails in place when necessary, and provide accurate detecting of their position to ensure uninterrupted operation in such environments.

### BRIEF DESCRIPTION OF DRAWINGS

Disclosed herein are embodiments of systems, apparatuses and methods pertaining to enabling mobile robots to travel through a doorway between two separate sections of a storage structure. This description includes drawings, wherein:

FIG. 1 is a schematic side view of a system of enabling mobile robots to travel through a doorway between two separate sections of a storage structure in accordance with some embodiments;

FIG. 2 is a block diagram of a computing device in accordance with some embodiments;

FIG. 3 is a front perspective front view of a portion of the system of FIG. 1 in accordance with some embodiments, showing a mobile robot arriving at the sliding door while the door is in the closed position, and while the rails (which are movable via a pivot mount) are in the first (obstructing) position;

FIG. 4 is the same view of the same portion of the system as in FIG. 3, but showing the sliding door while the door is in the open position, and the rails in the second (non-obstructing) position, and the mobile robot passing through the opening in the doorway;

FIG. 5 is a side elevational view of a tilt pivot and a rail and a mounting plate in accordance with some embodiments, showing a partial sectional view to show the interior components of the tilt pivot;

FIG. 6 is a front elevational view of a portion of the system of FIG. 1 in accordance with some embodiments, showing the sliding door while the door is in the closed position, and while the rails are in the first position;

FIG. 7 is the same view of the same portion of the system as in FIG. 6, showing the sliding door in a position between the closed position and the open position, and the rails in a position between the first (obstructing) position and the second position;

FIG. 8 is the same view of the same portion of the system as in FIG. 6, showing the sliding door in the open position, and the rails in the second position;

FIG. 9 is a side elevational view of a lead screw pivot and a rail and a mounting plate in accordance with some embodiments, showing a partial sectional view to show the components of the lead screw pivot; and

FIG. 10 is a front elevational view of a portion of the system of FIG. 1 in accordance with some embodiments, showing the sliding door while the door is in the closed position, and while the rails (which are movable via a lead screw) are in the first position;

FIG. 11 is the same view of the same portion of the system as in FIG. 10, showing the sliding door in a position between the closed position and the open position, and the rails in a position between the first (obstructing) position and the second position;

FIG. 12 is the same view of the same portion of the system as in FIG. 10, showing the sliding door in the open position, and the rails in the second position;

FIG. 13 is a block diagram of a method enabling mobile robots to travel through a doorway between two separate sections of a storage structure in accordance with some embodiments.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments. Also, common but well-understood elements that are useful or necessary in a commercially feasible embodiment are often not depicted in order to facilitate a less obstructed view of these various embodiments. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

The following description is not to be taken in a limiting sense, but is made merely for the purpose of describing the general principles of example embodiments. Reference throughout this specification to “one embodiment,” “an embodiment,” “some embodiments”, “an implementation”, “some implementations”, “some applications”, or similar language means that a particular feature, structure, or characteristic described in connection with the embodiment is included in at least one embodiment. Thus, appearances of the phrases “in one embodiment,” “in an embodiment,” “in some embodiments”, “in some implementations”, and similar language throughout this specification may, but do not necessarily, all refer to the same embodiment.

Generally speaking, pursuant to various embodiments, systems, apparatuses, and methods are provided herein useful for enabling mobile robots to travel between two distinct sections of a storage structure via a doorway. The system includes a door that moves between open and closed positions, and rails that shift between obstructing and clearing the doorway. When the door is open, the rails are positioned to allow the mobile robot to pass through the doorway, facilitating seamless travel between the separate sections. Conversely, when the door is closed, the rails obstruct the doorway, preventing the robot from passing through. The systems and methods described herein provide a reliable and efficient mechanism for coordinating the movement of the rails with the door, ensuring smooth operation in automated storage systems.

In some embodiments, a system for enabling mobile robots to travel through a doorway between two separate sections of a storage structure includes: a door configured to move between a closed position, where the door obstructs the doorway, and an open position, where the door does not obstruct the doorway; rails that move between a first position, where the rails obstruct the doorway, and a second position, where the rails do not obstruct the doorway; and a frame including pivots coupled to the rails. When the door is in the open position, the rails are in the second position, and a mobile robot is permitted to travel, on the rails and through the doorway, from one of the separate sections of the storage structure to other of the separate sections of the storage structure. When the door is in the closed position, the rails are in the first position, and the mobile robot is not permitted to travel, on the rails and through the doorway, from the one of the separate sections of the storage structure to the other of the separate sections of the storage structure.

In some embodiments, a method of enabling mobile robots to travel through a doorway between two separate sections of a storage structure includes: moving a door between a closed position, where the door obstructs the doorway, and an open position, where the door does not obstruct the doorway; moving rails between a first position, where the rails obstruct the doorway, and an second position, where the rails do not obstruct the doorway, wherein a frame including pivots is coupled to the rails; when the door is in the open position and the rails are in the second position, permitting a mobile robot to travel, on the rails and through the doorway, from one of the separate sections of the storage structure to other of the separate sections of the storage structure; and when the door is in the closed position and the rails are in the first position, not permitting the mobile robot to travel, on the rails and through the doorway, from the one of the separate sections of the storage structure to the other of the separate sections of the storage structure.

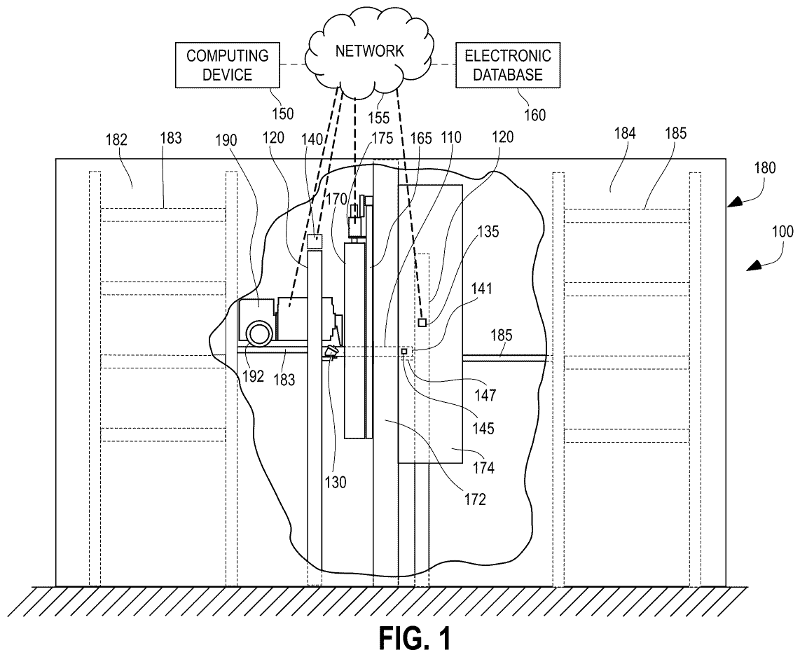

FIG. 1 illustrates a system 100 for enabling mobile robots 190 to travel through a doorway 188 between two separate sections 182, 184 of a storage structure 180. The example storage structure 180 may be located at any facility (e.g., a distribution facility, a fulfillment center, a store, etc.) where products (i.e., any kind of products that may be available for sale to consumers) may be stored. The example storage structure 180 depicted in FIG. 1 includes two separate sections, namely, a first section 182 (which may be, for example, a chiller section, refrigerator section, etc.) and a second section 184 (which may be, for example, a freezer section).

In the illustrated embodiment, the first section 182 includes rails 183 at multiple levels that permit a mobile robot 190 of a plurality of robots 190 to travel thereon while retrieving products from shelves/storage bins and/or while dropping off products to be stored on shelves/in storage bins. By the same token, the second section 184 includes rails 185 at multiple levels to permit a mobile robot 190 of a plurality of mobile robots 190 of the system 100 to travel thereon while retrieving products from shelves/storage bins and/or while dropping off products to be stored on shelves/in storage bins.

Generally speaking, the mobile robot 190 may be self-guided and/or rail-guided so as to move horizontally and vertically within the first and second sections 182, 184 of the storage structure 180. For example, the storage structure 180 may include a track system including horizontal rails may be affixed to product storage bays at different vertical levels. The horizontal rails 183, 185 may provide access to storage shelves on either side of an aisle on a given level, and the bays may include vertical level changing towers that permit the mobile robots 190 to travel vertically between the levels of the storage structure 180. In the embodiment illustrated in FIG. 1, the mobile robot 190 includes wheels 192 that may include features that couple to the rails 183, 185, but it will be appreciated that the mobile robot 190 may be configured without wheels and may couple to the rails 183, 185 via another suitable coupling that facilitates movement of the mobile robot 190.

Further details of the storage structure and mobile robots which may be used are described for example in the following U.S. patents and patent applications: U.S. Pat. No. 9,139,363, to John Lert, entitled “Automated System For Transporting Payloads,” issued Sep. 22, 2015; U.S. Pat. No. 10,435,241, to John Lert and William Fosnight, entitled, “Storage and Retrieval System,” issued Oct. 8, 2019; and U.S. Pat. No. 11,142,398, to John Lert and William Fosnight, entitled, “Order Fulfillment System,” issued Oct. 12, 2021, each of which is incorporated by reference herein in their entirety.

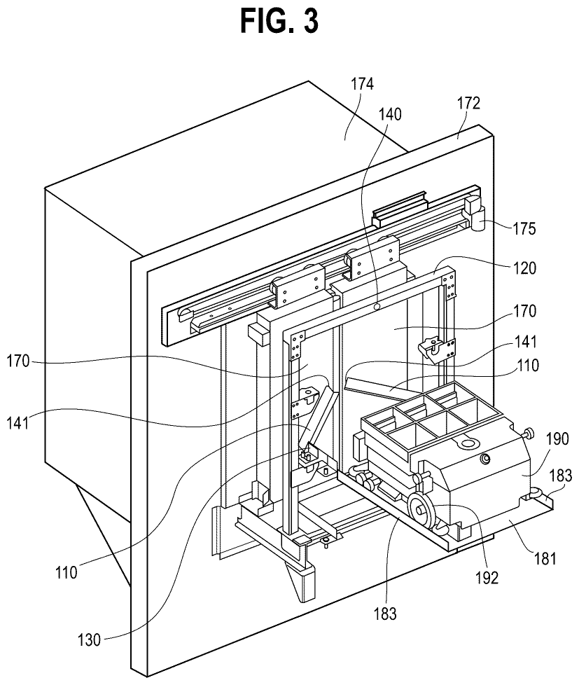

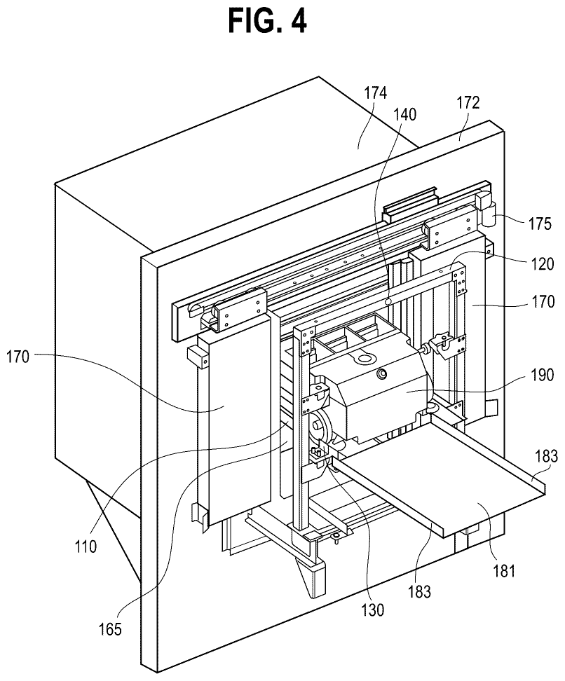

As shown in FIG. 1, the system 100 includes a movable door 170 that separates the first section 182 from the second section 184 of the storage structure 180 and either opens or closes a doorway 165 between the first and second sections 182, 184 of the storage structure 180. In some embodiments, the door 170 is movable between a closed position where the door 170 obstructs the doorway 165 (as shown in FIG. 3), and an open position where the door 170 does not obstruct the doorway 165 (as shown in FIG. 4).

Since the first and second sections 182, 184 separated by the door 170 have different interior temperature (e.g., the first section 182 has an interior temperature above 0° C. and the second section 184 has an interior temperature of below 0° C., the door 170 remains closed until a time when a mobile robot 190 is about to pass or is passing through the doorway 165 associated with the door 170, after which the door 170 closes again. Since the rails 110, when in a position that permits the mobile robot 190 to pass through the doorway 165 (while the door 170 is open) thereon, obstruct the movement of the door 170 back to the closed position of the door 170, to enable the door 170 to close, in the embodiment shown in FIG. 1, the system 100 includes rails 110 that move between a first position (in which the rails 110 obstruct the doorway 165 but do not obstruct the movement of the door 170) and a second position (in which the rails 110 do not obstruct the doorway 165, but obstruct the movement of the door 170). In the embodiment illustrated in FIGS. 3 and 4, the system 100 includes two rails 110 and a frame 120 including two pivots 130 each coupled to a respective one of the rails 110 and each permitting/causing the rails 110 to move between the first position and the second position.

In certain aspects, when the door 170 is in the closed position and obstructs the doorway 165, the door closes and hermetically seals the doorway 165 between the first section 182 and the second section 184 of the storage structure 180. In some embodiments, the system 100 includes a freezer wall 172 as shown in FIGS. 1, 3 and 4 between the first section 182 and the second section 184 of the storage structure 180. The freezer wall 172 may provide a physical barrier to separate the two temperature-different first and second sections 182, 184, ensuring that the second section 184 (e.g., the freezer section) stays at its required low temperature without allowing the warmer air from the first section 182 (e.g., the refrigerator section) to enter and disrupt the desired temperature in the second section 184, and ensuring that the significantly colder air from the second section 184 is not mixed with the significantly warmer air in the first section 182 to disrupt the desired temperature in the first section 182. Without wishing to be limited by theory, the freezer wall 172 may help minimize energy loss and may help to avoid moisture transfer (e.g., condensation) between the first and second sections 182, 184.

In some embodiments, the system 100 includes an air vestibule 174 as shown in FIGS. 1, 3 and 4 between the first section 182 and the second section 184 of the storage structure 180. In certain aspects, the air vestibule may include air curtains. The air vestibule 174 may act as a barrier to minimize the exchange of warm air from the ambient environment or from the first section 182, which may be a refrigerator section, with the colder air in the second section 184, which may be a freezer section, helping to maintain the desired temperature in the second section 184 and preventing an influx of heat, which may cause the second section 184 to work harder to maintain its low temperature, expending higher energy in the process.

In some aspects, air curtains of an air vestibule 174 may help maintain a comfortable temperature on the outside of the second section 184 when the door 170 is opened, making it easier for workers to access the storage structure 180 without causing significant temperature fluctuations in the second section 184.

As discussed in more detail below, the pivots 130 may be spring-loaded and biased in a direction toward the second position of the rails 110 (which is shown in FIG. 4). Since the door 170 is too heavy and strong for the pivots 130 to overcome, the rails 110 coupled to the pivots 130 remain in the first position (shown in FIG. 3) while the distal ends 141 (i.e., the free ends of the rails 110 that are not attached to the frame 120 or the pivots 130) of the rails 110 are in contact with the door 170. However, when the door 170 (which has two sliding door panels capable of laterally moving toward and away from each other as shown in FIGS. 3 and 4) starts moving (e.g., sliding) from the closed position (FIG. 3) toward the open position (FIG. 4), the distal ends 141 of the rails 110 are no longer prevented/restricted by the door 170 from moving. As a result, the pivots 130 cause the rails 110 to move together with the door in a generally downwardly direction from the first position (FIG. 3) toward the second position (FIG. 4) due to the biasing force of the spring-loaded pivots 130.

Notably, when the door 170 starts moving (e.g., sliding) from the open position (FIG. 4) toward the closed position (FIG. 3), the pivots 130 cause the rails 110 to move together with the door in a generally upwardly direction from the second position (FIG. 4) toward the first position (FIG. 3) due to the biasing force of the spring-loaded pivots 130. It is also be noted that the pivots 130 do not have to be spring-loaded and, in some aspects, the pivots 130 do not include a spring and are coupled to a motor instead, and the rails 110 are caused to move by the motor (e.g., in response to a signal sent by a computing device 150).

Generally speaking, as will be discussed in more detail below, the system 100 is configured such that when the door 170 is in the open position, the rails 110 are in the second position, and the mobile robot 190 is permitted to travel, via the rails 110 and through the doorway 165, from the rails 183 of the first section 182 of the storage structure 180 onto the rails 185 of the second section 184 of the storage structure 180 (e.g., as shown in FIGS. 1 and 4). On the other hand, when the door 170 is in the closed position, the rails 110 are in the first position, and the mobile robot 190 is not permitted to travel via the rails 110 through the doorway 165 from the first section 182 of the storage structure 180 to the second section 184 of the storage structure 180. With reference to FIGS. 3 and 4, the rails 183 on which the mobile robot 190 travels into proximity with the door 170 may be a part of a lift 181 configured to travel up and down relative to the multiple levels of the storage structure to align the wheels 192 of the mobile robot 190 with the rails 110 when the rails 110 are in the second position (shown in FIGS. 1 and 4).

In the illustrated embodiment, the frame 120 of the system 100 of FIG. 1 includes (or is coupled to) a one or more (e.g., two) proximity sensors 135 located adjacent a distal end 141 (i.e., a free end of the rails 110 that is not coupled to the pivot 130 or to the frame 120) of each of the two rails 110 to detect a location of each of the two rails 110 when the rails 110 are in the second position. In certain implementations, the proximity sensors 135 detect (e.g., continuously or at predetermined intervals, or in response to an activation signal) a position of each of the two rails 110 when the rails 110 are disposed in the second position, during movement of the rails 110 from the first position (FIG. 3) to the second position (FIG. 4), and/or during movement of the rails 110 from the second position to the first position. It will be appreciated that the physical location of the proximity sensor(s) 135 in FIG. 1 has been shown by way of example only, and that the proximity sensor(s) 135 may be located in another location that is suitable for detecting a location of the rails 110, and that the proximity sensor 135 may be optional in some embodiments.

In the illustrated embodiment, the system 100 includes a sensor 140 that detects a presence of the mobile robot 190 proximate the door 170 when the door 170 is in the closed position as shown. In some aspects, the sensor 140 is mounted on the frame 120 as shown in FIGS. 1, 3, and 4. It will be appreciated that the physical location of the sensor 140 in FIGS. 1, 3, and 4 has been shown by way of example only, and that the sensor 140 may be located in another location that is suitable for detecting a presence of the mobile robot 190 in proximity to the door 170, and that the sensor 140 may be optional in some embodiments.

In certain aspects, when the door 170 is open, the sensor 140 may detect the presence of the mobile robot 190 proximate the doorway 165 and/or in the doorway 165. In certain embodiments, the system 100 includes a computing device 150 and an electronic database 160, and the sensor may transmit signals containing sensor data to the computing device 150 and/or electronic database 160 over a network 155. The example network 155 depicted in FIG. 1 may be a wide-area network (WAN), a local area network (LAN), a personal area network (PAN), a wireless local area network (WLAN), Wi-Fi, Zigbee, Bluetooth (e.g., Bluetooth Low Energy (BLE) network), or any other internet or intranet network, or combinations of such networks. Generally, communication between various electronic devices of system 100 may take place over hard-wired, wireless, cellular, Wi-Fi or Bluetooth networked components or the like. It will be appreciated that the physical location of the sensor 140 in FIG. 1 has been shown by way of example only, and that the sensor 140 may be located in another location that is suitable for detecting a presence of the mobile robot 190 in proximity to the door 170 or in the doorway 165.

In some embodiments, the electronic database 160 and the computing device 150 may be implemented as two separate physical devices as shown in FIG. 1. It will be appreciated, however, that the computing device 150 and the electronic database 160 may be implemented as a single physical device. In some aspects, the electronic database 160 may be stored, for example, on non-volatile storage media (e.g., a hard drive, flash drive, or removable optical disk) internal or external to the computing device 150, or internal or external to computing devices distinct from the computing device 150. In some aspects, the electronic database 160 may be cloud-based. Generally, the example electronic database 160 of FIG. 1 may store data including but not limited to data associated with the transportation of products by mobile robots 190 (e.g., in the context of order fulfillment, product replenishment etc.), data associated with the locations of the mobile robots 190 throughout the system 100, sensor data generated as a result of detection of the mobile robots 190 (e.g., by the sensor 140), sensor data generated by the proximity sensor 135 as a result of detecting the location of the rails 110, etc.

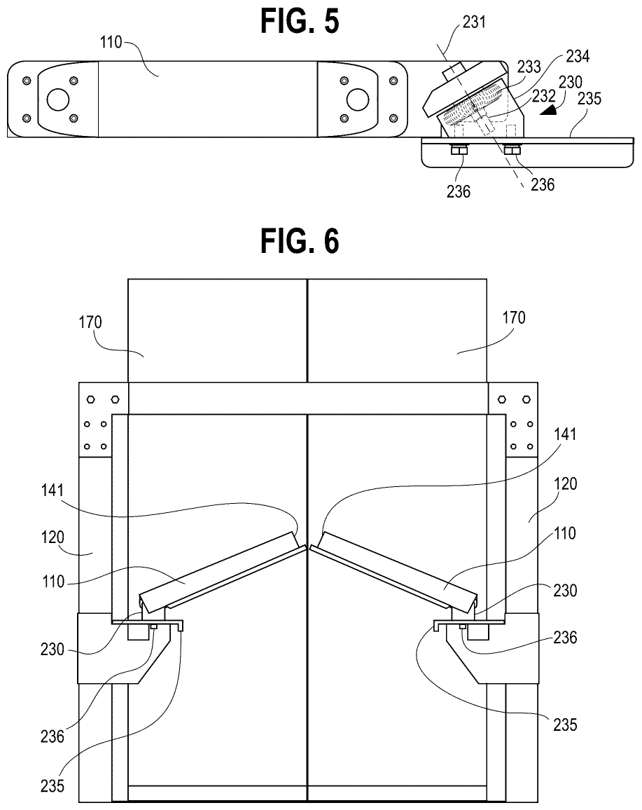

As mentioned above, the example system 100 shown in FIG. 5 further includes a computing device 150 configured to communicate with the electronic database 160, the sensors 135 and 140, and any other electronic components of the system 100 over the network 155. The computing device 150 may be a stationary or portable electronic device, for example, a desktop computer, a laptop computer, a tablet, a mobile phone, or any other electronic device including a control circuit (i.e., control unit) that includes a programmable processor. The computing device 150 may be configured for data entry and processing as well as for communication with other devices of system 100 via the network 155.

In certain aspects, the computing device 150 is configured to obtain data (e.g., sensor data generated by the sensor 140 indicating a detection of a mobile robot 190 proximate the door 170 and/or in the doorway 165. In some aspects, the computing device 150 is configured to obtain data (e.g., sensor data generated by the proximity sensor(s) 135 indicating a location of one or more rails 110 (e.g., during the movement of the rails 110 from the first position to the second position). In some aspects, the computing device 150 obtains the sensor data directly from the sensors 135 and 140 via the network 155. In other aspects, the computing device 150 obtains the sensor data from the electronic database 160 (i.e., the sensors 135 and 140 transmit sensor data to the electronic database 160 over the network 155, after which the computing device 150 obtains the sensor data from the electronic database 160 over the network 155).

In some implementations, after obtaining the sensor data generated by the sensor 140, the computing device 150 is configured to responsively transmit, via the network 155, at least one signal to a control unit 175 that controls the movement of the door 170 to cause the door 170 to move in a direction from the closed position to the open position, or in a direction from the open position to the closed position. In certain aspects, after obtaining the sensor data generated by the proximity sensor 135, the computing device 150 is configured to responsively transmit, via the network 155, at least one signal to the control unit 175 that controls the movement of the door 170 to cause the door 170 to stop moving or to start moving in a direction from the closed position to the open position, or in a direction from the open position to the closed position.

FIG. 5 shows an embodiment of a rail 110 coupled to a spring-loaded pivot 230 that is in the form of a tilt pivot. As illustrated, the pivot 230 has a housing 234 and a pivot pin 232 (or pivot shaft), a portion of which is retained within the housing 234 and a portion of which protrudes out of the housing 234. The pivot housing 234 further includes a spring 233 (e.g., a coil spring, a torsion spring, etc. that is wound or compressed to exert a force/bias that causes the rail 110 to move/pivot when the movement of the rail 110 is not prevented the door 170). As illustrated, the spring 233 extends radially around at least a portion of the pivot pin 232 and may substantially fully surround a circumference of the pivot pin 232 when the spring 233 is in the expanded position (not shown) and may surround a smaller portion of the circumference of the pivot pin 232 when the spring 233 is in the contracted position as in FIG. 5.

In the embodiment illustrated in FIG. 5, the pivot 230 is coupled to the frame 120 (shown in FIGS. 1 and 6-8) via a mounting plate 235 and two fasteners 236 (e.g., bolts) passing through the mounting plate 235 and into a portion of the housing 234. It will be appreciated that two fasteners 236 are shown in FIG. 5 by way of example only, and that only one fastener 236 may be used to secure the housing 234 of the pivot 230 to the mounting plate 235 in some embodiments. It will be appreciated that the mounting plate 235 may be optional in some embodiments, and that the pivot 230 may be coupled/mounted to the frame 120 via other suitable means.

In the embodiment illustrated in FIG. 5, the housing 234 and the pivot pin 232 are not oriented to be perpendicular relative to a horizontal plane, but are tilted relative to a horizontal plane such that an axis of rotation 231 of the pivot pin 232 is also tilted (e.g., at an angle between 30 and 90 degrees) relative to the horizontal plane. It will be appreciated that the angle of tilt of the pivot pin 232 of the pivot 230 in FIG. 5 is shown by way of example only, and that the pivot pin 232 of the pivot 230 may be tilted at a different angle (e.g., an angle that is less than 30 degrees relative to the horizontal plane).

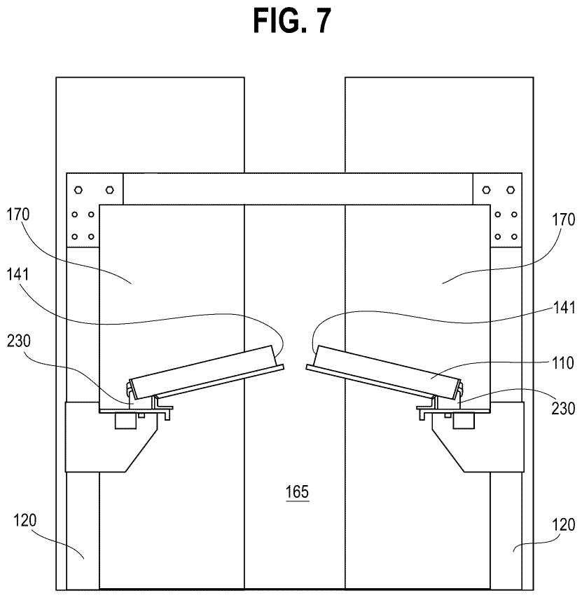

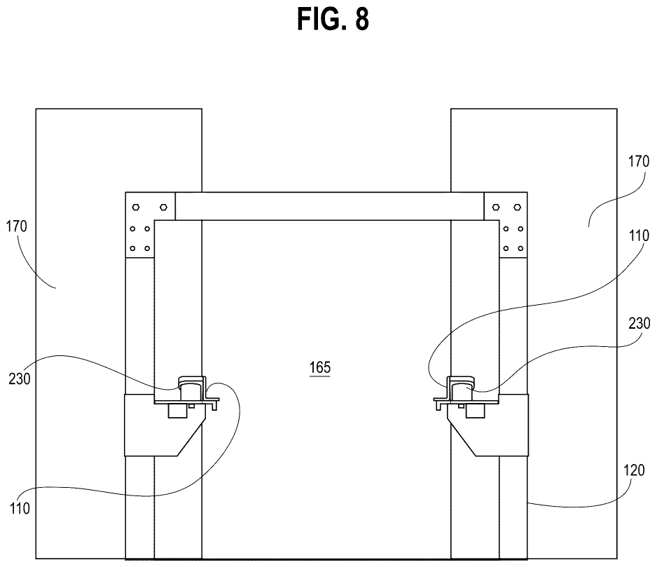

FIG. 6 illustrates an example embodiment of a portion of a system 100, showing the door 170 in a closed position and the rails 110 coupled to the frame 120 via the pivots 230 and in the first position. In the illustrated embodiment, the door 170 is a sliding door with two door panels that slide laterally (i.e., in a direction parallel to a horizontal plane) between the closed position shown in FIG. 6 and the open position shown in FIG. 8 (with FIG. 7 showing an example, where the panels of the door 170 are disposed in an intermediate position located between the closed position and the open position).

As shown in FIG. 6, when the rails 110 are in the first position, due to the nature of the angle of tilt of the pivot 230 described in the preceding paragraph, the rails 110 are not positioned vertically or horizontally, but are tilted (at an angle between 30 and 90 degrees) relative to the horizontal plane. In the embodiment illustrated in FIG. 6, the distal end 141 of each of the rails 110 is in contact with (i.e., is abutted by) the door 170. In the illustrated embodiment, the door 170 is made of a material and has a weight designed to withstand the bias of the spring 233 of the pivot 230, such that when the door 170 is in the closed position as shown in FIG. 6, the contact by (i.e., abutment of) the distal ends 141 of the rails 110 with the door 170 is not sufficient to cause the door 170 to move from the closed position to the open position. In other words, the door 170 prevents (restricts) the spring-loaded pivots 230 from causing the distal ends 141 of the rails 110 from moving from the first position as in FIG. 6 toward the second position as in FIG. 8.

On the other hand, when the door 170 moves (e.g., laterally slides) from the closed position of FIG. 6 toward the open position of FIG. 8, the spring-loaded pivots 230, by virtue of the spring 233 being biased toward the second position of the rails 110, and by virtue of the door 170 no longer being stationary and blocking the movement of the distal ends 141 of the rails 110, cause the rails 110 to move from the first position of FIG. 6 toward the second position of FIG. 8. In some embodiments, during the movement of the door 170 from the closed position toward the open position, the spring-loaded pivots 230 cause the rails 110 to move together with the door 170 and, as a result, when the door 170 reaches the open position to fully open the doorway 165 as shown in FIG. 8, the rails 110 reach the second position shown in FIG. 8 where the rails 110 are in a substantially horizontal position, where the rails 110 do not obstruct the doorway 165, and where the rails 110 are aligned with the wheels of the mobile robot 190 to permit the mobile robot 190 to travel on the rails 110 through the doorway 165 (as, shown, for example, in FIG. 4).

With reference to FIG. 7, which shows intermediate positions of the door 170 and the rails 110 between their respective positions shown in FIGS. 6 and 8, during the movement of the door 170 from the closed position toward the open position, as the rails 110 move together with the door 170 and are pivoted by the biasing force of the spring 233 of the pivot 230 in a direction toward the second position, the angle of the tilt of the rails 110 relative to the horizontal plane decreases in comparison to the original angle of the tilt of the rails 110 when the rails are in the first position shown in FIG. 6. In other words, during the movement of the door 170 from the closed position toward the open position, the rails 110 pivot from the tilted position when the rails 110 are in the first position as shown FIG. 6 to a horizontal position shown when the rails 110 are in the second position as shown in FIG. 8.

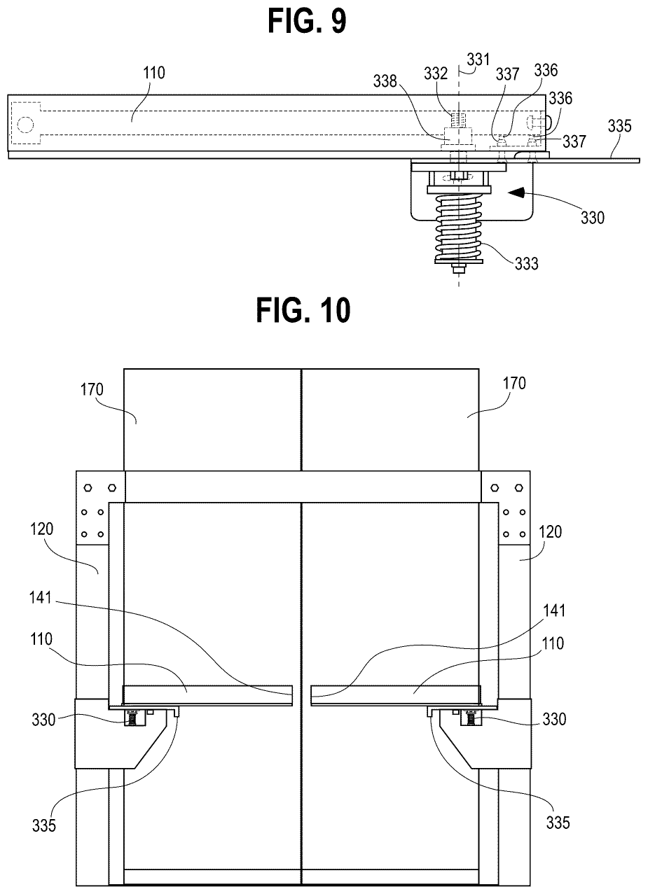

FIG. 9 shows an embodiment of a rail 110 coupled to a spring-loaded pivot 330 that is in the form of a lead screw pivot. The pivot 330 includes a shaft 332 (at least a portion of which may be threaded as shown in FIG. 9). The pivot 330 includes a spring 333 (e.g., a coil spring, a torsion spring, etc. that is wound or compressed to exert a force/bias that causes the rail 110 to move when the movement of the rail 110 is not obstructed by the door 170). In the embodiment shown in FIG. 9, the spring 333 is helically wound around a portion of the shaft 332 and longitudinally extends along a larger portion of the length of the shaft 332 when the spring 333 is in the expanded position as shown in FIG. 9, but along a smaller portion of the length of the shaft 332 when the spring 333 is in the contracted position (not shown).

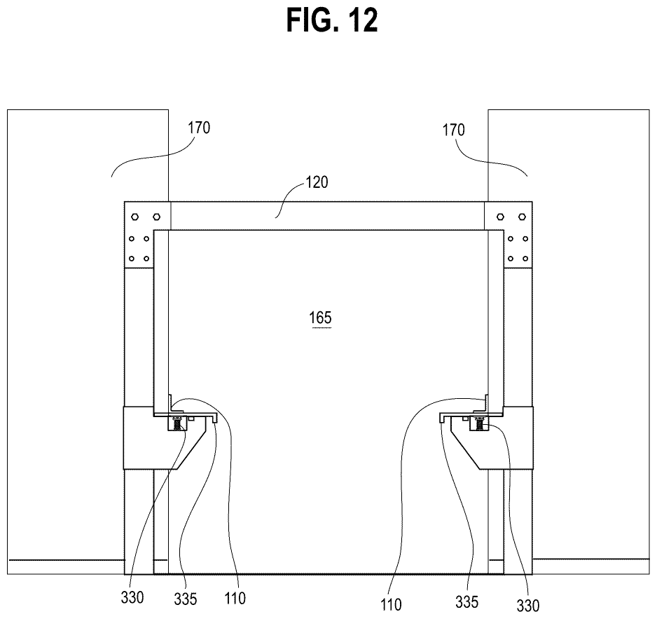

As illustrated in FIG. 9, the pivot 330 is coupled to the frame 120 (shown in FIGS. 1 and 6-8) via a mounting plate 335 and two fasteners 336 (e.g., bolts) each passing through the mounting plate 335 and secured by a nut 337. It will be appreciated that two fasteners 336 and two nuts 337 are shown in FIG. 9 by way of example only, and that only one fastener 336 and one nut 337 may be used to secure the 330 to the mounting plate 335 in some embodiments. In the embodiment illustrated in FIG. 9, the shaft 332 is coupled and secured relative to the mounting plate 335 via a nut 338, but the shaft 332 is permitted to rotate about an axis of rotation 331, for example, when the biasing force exerted by the spring 333 causes the shaft 332 to rotate (e.g., when the door 170 does not abut the free distal ends 141 of the rails 110 to prevent the movement of the rails 110 from the first position (FIG. 10) to the second position (FIG. 12). It will be appreciated that the mounting plate 335 may be optional in some embodiments, and that the pivot 330 may be coupled/mounted to the frame 120 via other suitable means.

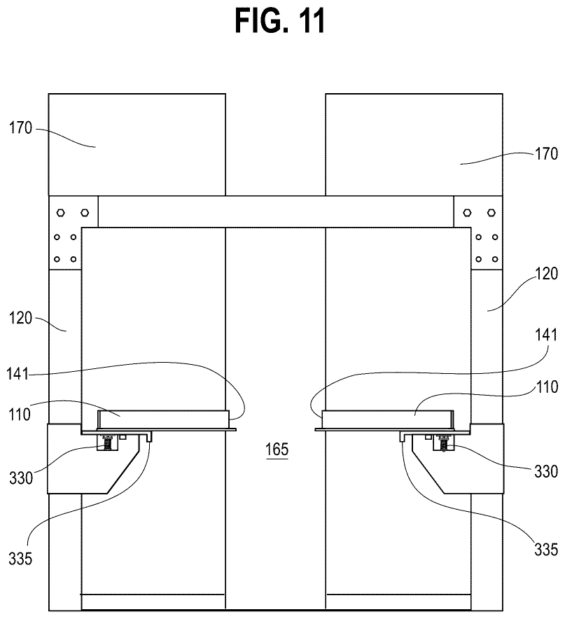

FIG. 10 illustrates an example embodiment of a portion of a system 100, showing the door 170 in a closed position and the rails 110 coupled to the frame 120 via the pivots 330 and in the first position. As mentioned above, in the illustrated embodiment, the door 170 is a sliding door including two door panels that slide laterally (i.e., in a direction parallel to a horizontal plane) between the closed position shown in FIG. 10 and the open position shown in FIG. 12 (with FIG. 11 showing an example, where the door panels of the door 170 are disposed in an intermediate position located between the closed position and the open position).

In the embodiment illustrated in FIG. 9, the shaft 332 of the pivot 330 is oriented to be perpendicular relative to a horizontal plane, such that the axis of rotation 331 of the shaft 332 is also perpendicular relative to the horizontal plane, as shown in FIG. 9. As a result of the vertical orientation of the shaft 332 of the pivot 330, the rails 110 remain in a horizontal orientation both when the rails 110 are in the first position (obstructing the doorway 165) shown in FIG. 10, when the rails are in the second position (not obstructing the doorway 165) shown in FIG. 12, and when the rails 110 are disposed at an intermediate location between the first position and second position as shown in FIG. 11.

With reference to FIG. 10, when the rails 110 are in the first position, since the shaft 332 is oriented vertically and the axis of rotation 331 of the shaft 332 is perpendicular to the horizontal plane, the rails 110 are positioned horizontally. In the embodiment illustrated in FIG. 10, the distal ends 141 of the rails 110 are shown to be spaced apart from (and not in contact with) each other when the rails 110 are in the first position, but, in some embodiments the distal ends 141 of the rails 110 may be in contact with each other when the rails 110 are in the first position.

In the embodiment illustrated in FIG. 10, the distal end 141 of each of the rails 110 is in contact with (i.e., is abutted by) the door 170. In the illustrated embodiment, the door 170 is made of a material and has a weight designed to withstand the bias of the spring 333 of the pivot 330. In other words, when the door 170 is in the closed position as shown in FIG. 10, the contact by (i.e., abutment of) the distal ends 141 of the rails 110 with the door 170 prevents the spring-loaded pivots 330 from causing the distal ends 141 of the rails 110 to move from the first position shown in FIG. 10 toward the second position shown in FIG. 12.

On the other hand, when the door panels of the door 170 move (e.g., laterally slide) from the closed position of FIG. 10 toward the open position of FIG. 12, the spring-loaded pivots 330, by virtue of the spring 333 being biased toward the second position of the rails 110, and by virtue of the door 170 no longer blocking the pivoting movement of the distal ends 141 of the rails 110, cause the rails 110 to move from the first position of FIG. 10 toward the second position of FIG. 12. With reference to FIG. 11, which shows intermediate positions of the door 170 and the rails 110 between their respective positions shown in FIGS. 10 and 12, during the movement of the door 170 from the closed position toward the open position, as the rails 110 move together with the door 170 and are pivoted by the biasing force of the spring 333 of the pivot 330 in a direction toward the second position, the rails 110 are in the horizontal position. In other words, during the movement of the door 170 from the closed position toward the open position, the rails 110 pivot about the axis of rotation 331 relative to the shaft 332, but remain in a horizontal position.

In some embodiments, during the movement of the door 170 from the closed position toward the open position, the spring-loaded pivots 330 cause the rails 110 to move together with the door 170 and, as a result, when the door 170 reaches the open position to fully open the doorway 165 as shown in FIG. 12, the rails 110 reach the second position shown in FIG. 12, where the rails 110 are also in a horizontal position and do not obstruct the doorway 165 and are aligned with the wheels of the mobile robot 190 to permit the mobile robot 190 to travel on the rails 110 through the doorway 165 (as, shown, for example, in FIG. 4).

In certain embodiments, each of the rails 110 includes a feature that facilitates the retention of the rails 110 in their second position (in which the rails 110 do not obstruct the doorway 165). In the embodiment illustrated in FIG. 1, each of the rails 110 includes a magnet 145 coupled thereto (e.g., adhered thereto using tape, adhesive, etc.) proximate a distal end 141 of the rails 110. To complement the magnet 145, the frame 120 includes a metallic plate 147 (which may instead be a metallic bracket or another metallic structure) located on the frame 120 adjacent a position of a distal end 141 of each of the rails 110 when the rails 110 are in the second position. Due to the magnetic attraction/engagement of the magnet 145 and the metallic plate 147, when the rails 110 are in the second position as shown in FIGS. 1, 4, 8 and 12, the magnet 145 of each of the rails 110 magnetically engages to the respective metallic plate 147 and provides a force additional to the biasing force of the spring (e.g., 233, 333) of the spring-loaded pivot (e.g., 230, 330) to facilitates securely retaining the rails 110 in the second position.

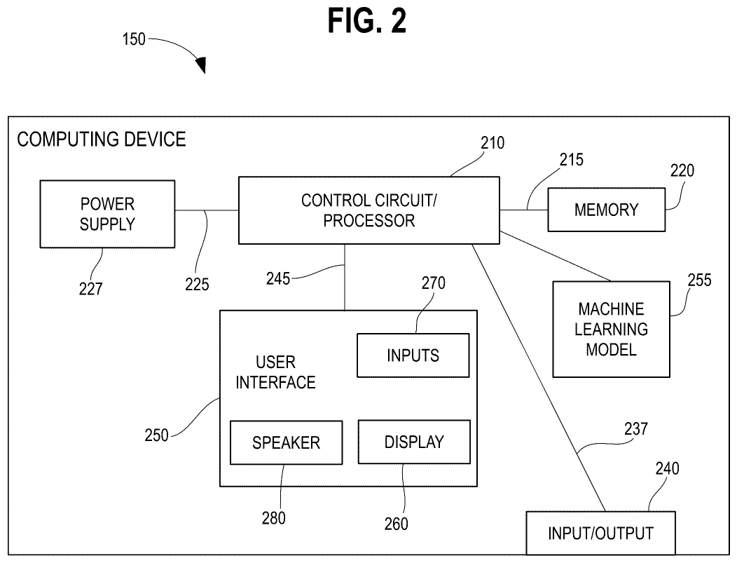

With reference to FIG. 2, the example computing device 150 configured for use with example systems and methods described herein may include a control circuit 210 including a programmable processor (e.g., a microprocessor or a microcontroller) electrically coupled via a connection 215 to a memory 220 and via a connection 225 to a power supply 227. The control circuit 210 can comprise a fixed-purpose hard-wired platform or can comprise a partially or wholly programmable platform, such as a microcontroller, an application specification integrated circuit, a field programmable gate array, and so on. These architectural options are well known and understood in the art and require no further description here.

The control circuit 210 can be configured (for example, by using corresponding programming stored in the memory 220 as will be well understood by those skilled in the art) to carry out one or more of the steps, actions, and/or functions described herein. In some embodiments, the memory 220 may be integral to the processor-based control circuit 210 or can be physically discrete (in whole or in part) from the control circuit 210 and is configured non-transitorily store the computer instructions that, when executed by the control circuit 210, cause the control circuit 210 to behave as described herein. (As used herein, this reference to “non-transitorily” will be understood to refer to a non-ephemeral state for the stored contents (and hence excludes when the stored contents merely constitute signals or waves) rather than volatility of the storage media itself and hence includes both non-volatile memory (such as read-only memory (ROM)) as well as volatile memory (such as an erasable programmable read-only memory (EPROM))). Accordingly, the memory and/or the control unit may be referred to as a non-transitory medium or non-transitory computer readable medium.

In the illustrated embodiment, the control circuit 210 of the computing device 150 is also electrically coupled via a connection 237 to an input/output 240 that can receive signals from, for example, from a sensor 135, 140, electronic database 160, mobile robot 190, and/or from another electronic device. The input/output 240 of the computing device 150 can also send signals to other devices, for example, a signal to the electronic database 160 to obtain sensor data and/or a signal to the mobile robot 190 to control movement of the mobile robot 190, and/or a signal to a control unit 175 that may be coupled to a motor that causes the door 170 to open.

For example, in some aspects, the control circuit 210 is programmed to process the sensor data (e.g., an image captured by the sensor 140) and to extract raw image data and metadata from the image, and to cause transmission of the raw data extracted from the image to the electronic database 160 for storage. In some aspects, the control circuit 210 may process the image captured by the sensor 140 to detect the presence of a mobile robot 190 in proximity to the door 170 and to transmit a signal that causes the door to open to permit the mobile robot 190 to go through the doorway 165 as described in more detail above.

The processor-based control circuit 210 of the computing device 150 shown in FIG. 2 is electrically coupled via a connection 245 to a user interface 250, which may include a visual display or display screen 260 (e.g., LED screen) and/or button input 270 that provide the user interface 250 with the ability to permit an operator of the system 100 (e.g., a worker tasked with overseeing operation of the system 100) to manually control the computing device 150 by inputting commands via touch-screen and/or button operation and/or voice commands.

In some aspects, the manual control by an operator of the computing device 150 may be via the user interface 250 of the computing device 150, via another electronic device of the operator, or via another user interface and/or switch, and may include an option to process the image captured by the sensor 140 using a machine learning model 255 to facilitate the object detection (e.g., to detect the presence of the mobile robot 190 in an image no matter what objects the mobile robot 190 is transporting). In some aspects, the user interface 250 of the computing device 150 may also include a speaker 280 that provides audible feedback (e.g., alerts) to the operator of the computing device 150. It will be appreciated that the performance of such functions by the control circuit 210 is not dependent on a human operator, and that the control circuit 210 may be programmed to perform such functions without a human operator.

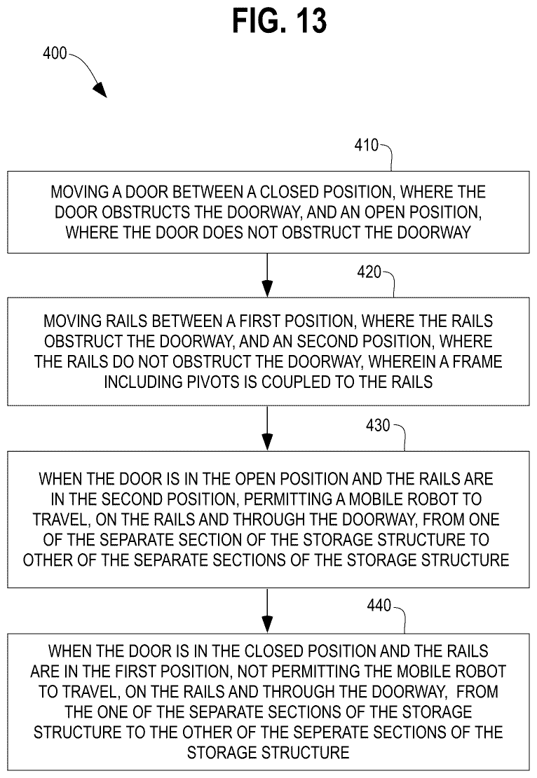

FIG. 7 is a flow chart depicting an example method 400 of enabling mobile robots to travel through a doorway between two separate sections of a storage structure. In the embodiment illustrated in FIG. 13, step 410 of the method 400 includes moving a door between a closed position, where the door obstructs the doorway, and an open position, where the door does not obstruct the doorway. Further, step 420 of the method 400 includes moving rails between a first position, where the rails obstruct the doorway, and a second position, where the rails do not obstruct the doorway, wherein a frame including pivots is coupled to the rails. Step 430 of the method 400 includes, when the door is in the open position and the rails are in the second position, permitting a mobile robot to travel, on the rails and through the doorway, from one of the separate sections of the storage structure to other of the separate sections of the storage structure. Finally, step 440 of the method 400 includes, when the door is in the closed position and the rails are in the first position, not permitting the mobile robot to travel, on the rails and through the doorway, from the one of the separate sections of the storage structure to the other of the separate sections of the storage structure.

The apparatuses, systems, and methods described above provide advantages over existing systems for managing the movement of mobile robots in automated storage structures. By coordinating the movement of rails with the opening and closing of the door, the system ensures seamless robot travel between distinct sections, such as chilled and frozen areas, without the need for complex or manual interventions. The use of a pivoting mechanism allows the rails to move automatically in response to the door's position, reducing the potential for failure and ensuring consistent operation. Overall, this system enhances efficiency, reliability, and ease of use in automated environments, while minimizing the need for maintenance or manual adjustment.

Those skilled in the art will recognize that a wide variety of other modifications, alterations, and combinations can also be made with respect to the above-described embodiments without departing from the scope of the disclosure, and that such modifications, alterations, and combinations are to be viewed as being within the ambit of the inventive concept.

1. A system for enabling mobile robots to travel through a doorway between two separate sections of a storage structure, the system comprising:
a door configured to move between a closed position, where the door obstructs the doorway, and an open position, where the door does not obstruct the doorway;
rails that move between a first position, where the rails obstruct the doorway, and a second position, where the rails do not obstruct the doorway; and
a frame including pivots coupled to the rails;
wherein:
when the door is in the open position, the rails are in the second position, and a mobile robot is permitted to travel, on the rails and through the doorway, from one of the separate sections of the storage structure to other of the separate sections of the storage structure; and
when the door is in the closed position, the rails are in the first position, and the mobile robot is not permitted to travel, on the rails and through the doorway, from the one of the separate sections of the storage structure to the other of the separate sections of the storage structure.

2. The system of claim 1, wherein:
each of the pivots is a spring-loaded pivot;
when the door is closed, the rails are in the first position and abut the door and the door restricts the rails from moving from the first position toward the second position; and
during movement of the door from the closed position toward the open position, the spring-loaded pivots cause the rails to move from the first position toward the second position.

3. The system of claim 2, during the movement of the door from the closed position toward the open position, the spring-loaded pivots cause the rails to move together with the door, such that when the door reaches the open position, the rails reach the second position to permit the mobile robot to travel on the rails through the doorway.

4. The system of claim 2, wherein:
the spring-loaded pivot is a tilt pivot;
during movement of the rails from the second position, where the rails are disposed in a horizontal orientation, toward the first position, the tilt pivot causes a free distal end of the rails to tilt in an upwardly direction such that when the rails reach the first position, the rails are disposed in a tilted orientation at an angle of about 30-90 degrees relative to the horizontal orientation of the rails when the rails are in the second position; and
during the movement of the rails from the first position, where the rails are disposed in the tilted orientation, toward the first position, the tilt pivot causes the distal end of the rails to tilt in a downwardly direction such that when the rails reach the second position, the rails are disposed in the horizontal orientation.

5. The system of claim 2, wherein:
the spring-loaded pivot is a lead screw pivot; and
during movement of the rails from the second position, where the rails are disposed in a horizontal orientation, toward the first position, the lead screw pivot causes a free distal end of the rails to not tilt such that, when the rails reach the first position, the rails are disposed in the horizontal orientation.

6. The system of claim 1, wherein:
the frame includes a metallic plate located adjacent a position of a free distal end of each of the rails when the rails are in the second position;
each of the rails includes a magnet coupled thereto proximate the distal end; and
when the rails are in the second position, the magnet of each of the rails magnetically engages to the respective metallic plate to securely retain the rails in the second position.

7. The system of claim 1, wherein:
the frame includes a proximity sensor located adjacent a position of a free distal end of each of the rails when the rails are in the second position; and
the proximity sensor detects a position of the rails during movement of the rails from the first position to the second position, from the second position to the first position, and when the rails are in the second position.

8. The system of claim 1, further comprising at least one sensor configured to detect a presence of the mobile robot proximate the door when the door is in the closed position and proximate the doorway when the door is in the open position.

9. The system of claim 8, further comprising a processor-based computing device in communication with the at least one sensor, wherein the computing device obtains sensor data from the at least one sensor, and when the sensor data indicates that the mobile robot is detected proximate the door when the door is in the closed position, the computing device transmits a signal that causes the door to move from the closed position to the open position.

10. The system of claim 1, wherein a first section of the storage structure is a freezer section, and a second section of the storage structure is a refrigerator section, and wherein the door, when in the closed position, seals the doorway between the first section and the second section.

11. A method of enabling mobile robots to travel through a doorway between two separate sections of a storage structure, the method comprising:
moving a door between a closed position, where the door obstructs the doorway, and an open position, where the door does not obstruct the doorway;
moving rails between a first position, where the rails obstruct the doorway, and an second position, where the rails do not obstruct the doorway, wherein a frame including pivots is coupled to the rails;
when the door is in the open position and the rails are in the second position, permitting a mobile robot to travel, on the rails and through the doorway, from one of the separate sections of the storage structure to other of the separate sections of the storage structure; and
when the door is in the closed position and the rails are in the first position, not permitting the mobile robot to travel, on the rails and through the doorway, from the one of the separate sections of the storage structure to the other of the separate sections of the storage structure.

12. The method of claim 11, wherein each of the pivots is a spring-loaded pivot, and wherein, when the door is closed, the rails are in the closed position and abut the door, and the door restricts the rails from moving from the first position toward the second position, and further comprising:
during movement of the door from the first position toward the second position, causing, by the spring-loaded pivots, the rails to move from the first position toward the first position.

13. The method of claim 12, further comprising, during the movement of the door from the closed position toward the open position, causing, by the spring-loaded pivots, the rails to move together with the door, such that when the door reaches the open position, the rails reach the second position to permit the mobile robot to travel on the rails through the doorway.

14. The method of claim 12, wherein the spring-loaded pivot is a tilt pivot, and further comprising:
during movement of the rails from the second position, where the rails are disposed in a horizontal orientation, toward the first position, causing, by the tilt pivot, a free distal end of the rails to tilt in an upwardly direction such that when the rails reach the first position, the rails are disposed in a tilted orientation at an angle of about 30-90 degrees relative to the horizontal orientation of the rails when the rails are in the second position; and
during the movement of the rails from the first position, where the rails are disposed in the tilted orientation, toward the first position, causing, by the tilt pivot, the distal end of the rails to tilt in a downwardly direction such that when the rails reach the second position, the rails are disposed in the horizontal orientation.

15. The method of claim 12, wherein the spring-loaded pivot is a lead screw pivot, and further comprising:
during movement of the rails from the second position, where the rails are disposed in a horizontal orientation, toward the first position, causing, by the lead screw pivot, a free distal end of the rails to not tilt such that, when the rails reach the first position, the rails are disposed in the horizontal orientation.

16. The method of claim 11, wherein the frame includes a metallic plate located adjacent a position of a free distal end of each of the rails when the rails are in the second position, and each of the rails includes a magnet coupled thereto proximate the distal end, and further comprising, when the rails are in the second position, securely retaining the rails in the second position via the magnet of each of the rails magnetically engaging the respective metallic plate.

17. The method of claim 11, wherein the frame includes a proximity sensor located adjacent a position of a free distal end of each of the rails when the rails are in the open position, and further comprising detecting, by the proximity sensor, a position of the rails during movement of the rails from the first position to the second position, from the second position to the first position, and when the rails are in the second position.

18. The method of claim 11, further comprising detecting, by at least one sensor, a presence of the mobile robot proximate the door when the door is in the closed position and proximate the doorway when the door is in the open position.

19. The method of claim 18, further comprising, by a processor-based computing device in communication with the at least one sensor:
obtaining sensor data from the at least one sensor; and
when the sensor data indicates that the mobile robot is detected proximate to the door when the door is in the closed position, transmitting a signal that causes the door to move from the closed position to the open position.

20. The method of claim 11, wherein a first section of the storage structure is a freezer section, and a second section of the storage structure is a refrigerator section, and wherein the door, when in the closed position, seals the doorway between the first section and the second section.
